(19) United States
(12) Patent Application Publication
(10) Pub. No.: US 2014/0273803 A1
(43) Pub. Date: Sep. 18, 2014

(54) AIRFLOW DIFFUSER WITH INTEGRATED LIGHT FIXTURE

(71) Applicant: Fontanesi and Kann Company, Oak Park, MI (US)

(72) Inventor: Joseph Fontanesi, Bloomfield Hills, MI (US)

(21) Appl. No.: 14/293,393

(22) Filed: Jun. 2, 2014

Related U.S. Application Data
(63) Continuation of application No. 13/910,589, filed on Jun. 5, 2013.

(51) Int. Cl. F21V 29/00

(52) U.S. Cl. CPC F21V 29/002
USPC 454/293

(57) ABSTRACT

An airflow diffuser unit that is operable to receive a light fixture assembly to form a single, integrated assembly. The airflow diffuser unit includes a housing with an inlet collar for coupling to an airflow source. The airflow diffuser unit further includes a diffuser panel to facilitate airflow egress from the housing. An air filter can be placed between the inlet collar and a diffuser panel. The light fixture assembly is received into the housing and is secured thereto with a plurality of fasteners. The fasteners can be disengaged to remove the light fixture assembly from the housing. The light fixture assembly includes at least one pair of light receptacles, a light diffuser panel, and at least one electrical plug connector.

### CROSS-REFERENCE TO RELATED APPLICATIONS

This application is a continuation of U.S. patent application Ser. No. 13/910,589, filed Jun. 5, 2013 which claims the benefit of U.S. Provisional Application No. 61/656,071, filed on Jun. 6, 2012. The entire disclosure of the above application is hereby incorporated by reference.

### TECHNICAL FIELD

The present disclosure relates generally to an airflow diffuser unit and a light fixture assembly, and, more specifically, to an airflow diffuser unit adapted to receive a light fixture assembly, thereby forming a single, integrated assembly.

### BACKGROUND

The statements in this section merely provide background information related to the present disclosure and may not constitute prior art.

A variety of competing interests exist between the desire to achieve an optimum lighting arrangement in a room and the desire to achieve optimum air ventilation in a room. For example, located in the ceiling of most rooms in a vast majority of residential and/or commercial buildings are a collaboration of individual airflow diffuser units and individual light fixtures. During installation, these units and fixtures must be individually arranged and accommodated for within a certain ceiling and/or room footprint. More often than not, however, a restricted ceiling space, a room layout constraint, or a combination of both, serves to limit the exact location into which these units and fixtures can be installed. As a result, the end user may be required to make use of a room that compromises air ventilation, lighting, or both.

In another similar example, the Standards Committee of the American Society of Heating, Refrigerating and Air-Conditioning Engineers (ASHRAE) has recently approved a standard for venting operating theaters. Prior to the standard, most operating theatres included a light fixture installed overhead a patient and surgical team working in the operating theatre. Now, the standard requires, amongst other conditions, that an airflow diffuser unit be installed overhead a patient and surgical team working in the operating theatre. As a result, the surgical teams are now challenged and required to work in a compromised lighting environment because the previously installed overhead light fixture has been repositioned elsewhere to make space for the required overhead airflow diffuser unit.

It is therefore apparent that a remedy to the above described constraints relating to the placement of airflow diffuser units and light fixture assemblies is needed.

### SUMMARY

The present disclosure provides an airflow diffuser unit operable to receive a light fixture to form a single, integrated assembly.

In one aspect of the disclosure, an assembly comprises an airflow diffuser unit comprising a housing coupled to a source of airflow. The airflow diffuser unit further comprises an airflow diffuser panel coupled to the housing. The airflow is directed through the housing and the airflow diffuser panel. A light fixture assembly comprises at least one light receptacle. The light fixture assembly is received within and coupled to the housing so that the airflow is directed to the light fixture assembly.

In another aspect of the disclosure, a fixture comprises an airflow diffuser unit comprising a housing coupled to a source of airflow. The airflow diffuser unit further comprises a laminar airflow diffuser panel secured to the housing. The airflow is directed through the housing and the laminar airflow diffuser panel. A light fixture assembly is received into the airflow diffuser unit and secured to the housing. The airflow is directed toward and into the light fixture assembly. The light fixture assembly comprises a frame coupled to a bezel. The frame comprises at least one light receptacle. The light fixture assembly further comprises a lens frame coupled to the bezel and receives a light diffuser.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of the integrated airflow diffuser unit and light fixture of the present disclosure;

FIG. 2 is a bottom view of the integrated airflow diffuser unit and light fixture of the present disclosure;

FIG. 3 is a cross-sectional view of the integrated airflow diffuser unit and light fixture of the present disclosure taken along line 2-2 of FIG. 2.

FIG. 4 is a side view of the light fixture that is adapted to be received into the airflow diffuser unit;

FIG. 5 is a detailed view of feature 5 of FIG. 3;

FIG. 6 is a detailed view of feature 6 of FIG. 4; and

FIG. 7 is an alternative example of the face portion of the airflow diffuser panel.

Corresponding reference numerals indicate corresponding parts throughout the several views of the drawings.

### DETAILED DESCRIPTION

The following description is merely exemplary in nature and is not intended to limit the present disclosure, application, or uses. For purposes of clarity, the same reference numbers will be used in the drawings to identify similar elements.

Examples are provided so that this description will be thorough, and will fully convey the scope to those who are skilled in the art. Numerous specific details are set forth such as examples of specific components and methods, to provide a thorough understanding of examples of the present disclosure. It will be apparent to those skilled in the art that specific details need not be employed, that examples may be embodied in many different forms and that neither should be construed to limit the scope of the description.

With reference to the figures, and specifically to FIGS. 1 through 3, an integrated airflow diffuser unit and light fixture (assembly) 10 is illustrated. Specifically, the assembly 10 comprises an airflow diffuser unit 12 that is configured to receive a light fixture assembly 14. A plurality of hanger flanges 16, each including an aperture 18, is attached to the assembly 10. The hanger flanges 16 are employed to suspend the assembly 10 from, for example, a drop ceiling (not illustrated).

The airflow diffuser unit 12 comprises a housing 20. The housing 20 can further comprise a first stepped portion 22, a second stepped portion 24 and an inlet collar 26. The first and second stepped portions 22, 24, and the inlet collar 26, can be fabricated from a single piece of sheet metal, aluminum or like suitable material and can be formed by known flattening, notching, and/or folding methods. Some or all of the previously mentioned sections 22, 24 and 26 can also be fabricated from a combination of individual pieces of suitable material and subsequently joined together by known joining methods such as, for example, welding or screws (not illustrated). Regardless of the method of fabrication, the housing 20 is a generally hollow and sealed structure, save for an air inlet aperture 28 and an air outlet aperture 30 disposed at opposite ends of the housing 20.

The air inlet aperture 28 is generally located within the inlet collar 26. The inlet collar 26 operates to couple the housing 20 of the assembly 10 to an orifice located in a heating, ventilation, and air conditioning duct (HVAC) duct (not illustrated). An HVAC duct is a generally round, or a generally rectangular, metal or flexible plastic pipe designed to displace air generated by a source, such as, for example, an air conditioner, furnace or fan. The inlet collar 26 may be coupled to the HVAC duct orifice by a suitable coupling means, such as, for example, a hose clamp (not illustrated). Once coupled to the HVAC duct orifice, the assembly 10 serves to circulate and vent the air generated by the source into the various rooms in a building (not illustrated).

The air outlet aperture 30 is employed by the housing 20 of the assembly 10 to accommodate an airflow diffuser panel 32 and the light fixture assembly 14.

The airflow diffuser panel 32 can be fabricated from sheet metal, aluminum, plastic or a like suitable material. The airflow diffuser panel 32 comprises a frame portion 34 and a face portion 36. The frame portion 34 forms a border about the perimeter of the face portion 36.

With additional reference to FIGS. 5 and 6, the frame portion 34 includes a plurality of apertures 37 operable to accept a plurality of fasteners 39. The fasteners 39 secure the airflow diffuser panel 32 to the housing 20. Periodically, the airflow diffuser panel 32 may need to be removed from the housing 20 to, for example, perform preventative maintenance and/or service on the assembly 10. As such, the fasteners 39 are removable quarter-turn fasteners. Quarter-turn fasteners are known in the industry and are used in applications to quickly and easily, but securely, attach and detach two members, without the need for complex tools. An industry example of a quarter-turn fastener is a SouthCo no. 82 stud fastener, and matching receptacle. A tether (not illustrated), such as a chain, can attach the quarter-turn fasteners to the housing 20. The tether can prevent misplacement of the fasteners 39 when the fasteners 39 are removed from the housing 20.

As illustrated in FIGS. 1 and 2, the face portion 36 of the airflow diffuser panel 32 comprises perforations 35 of various configurations. The perforations 35 are designed to provide laminar airflow egress from the assembly 10. Laminar airflow is a principle of fluid dynamics that occurs when air flows in a single direction in parallel layers, with no disruption between the layers. Laminar airflow is preferred in environments such as operating theatres, laboratories and clean rooms. For example, studies have shown that laminar airflow in operating theatres can assist in maintaining a sterile operating environment by reducing the presence of dirt particles, infective organisms and bacteria in the air.

In an alternative example illustrated in FIG. 7, the face portion 36 of the airflow diffuser panel 32 can comprise rectangular louvers 35′. The rectangular louvers 35′ can provide turbulent airflow egress from the assembly 10. Turbulent airflow is a principle of fluid dynamics that occurs when air flows in multiple, non-parallel layers and in various directions causing the air molecules to mix. Further, in addition to, or, in lieu of the rectangular louvers 35′, the face portion 36 of the airflow diffuser panel 32 can comprise various-sized concentric circular or rectangular baffles (not illustrated).

With continued reference to FIG. 7, the airflow diffuser panel 32 also includes an adjustment means 41. The adjustment means 41 provides for custom control and management of the intensity and direction of airflow egress from the assembly 10.

The frame potion 34 and/or the airflow diffuser panel 32 can comprise an aesthetic, decorative finish (not illustrated). The decorative finish may include, for example, a specific color and/or grain to match and accent the decor of the surrounding environment into which the assembly 10 is installed.

With reference to FIG. 3, a High-Efficiency Particulate Air (HEPA) filter 38 is installed within the housing 20, at a location between the inlet collar 26 and the airflow diffuser panel 32. The HEPA filter 38 comprises a mat of randomly arranged fiberglass fibers that operate to trap and remove airborne particles larger than 0.3 μm with an efficiency of 99.99% from the air flowing through the HEPA filter 38. The HEPA filter 38 assists in preventing the recirculation and spread of airborne bacterial and viral organisms.

A plurality of rigid, spring-retainer clip fingers 40 securely fasten the HEPA filter 38 to the housing 20. By applying a force and biasing the spring-retainer clip fingers 40, the clip fingers 40 release the HEPA filter 38 from the housing 20. This fastening means 40 is ideal for the facilitation of any required preventative maintenance and/or service of the filter 38, without the need for complex tools and/or complex assembly and dis-assembly procedures.

As described above, in addition to the airflow diffuser panel 32, the light fixture assembly 14 is also received into the air outlet aperture 30 of the housing 20. With reference to FIGS. 3 through 6, the light fixture assembly 14 comprises a wire way assembly 42, a housing assembly 44 and a light diffuser assembly 46.

The wire way assembly 42 comprises a wire way trough 48 and a wire way closeout panel 50. Both components 48, 50 can be formed by an extrusion, stamping, or cold-rolling process from sheet metal, aluminum or a like suitable material. Disposed throughout the trough 48 and the panel 50 are a plurality of ports 52 of various sizes and configurations. The ports 52 provide a means for air flowing through the housing 20 to enter the wire way assembly 42 and cool the components of the light fixture assembly 14 contained therein.

The ports 52 also cooperate with the trough 48 to route and accommodate various electrical wires and components, illustrated generally at 53, that are typically associated with a conventional lighting system. These components 53 are generally known in the industry and will not be discussed in detail herein.

With specific reference to FIGS. 3 and 5, the trough 48 generally comprises a Y-shaped cross-sectional profile. The close out panel 50 is received into and coupled to the trough 48 by an interference force fit. In an alternative example (not illustrated), a fastener, such as a pop-rivet, screw or peg can be used to secure the panel 50 and the trough 48. The panel 50 serves to protect the previously mentioned electrical wires and components 53 disposed in the trough 48 from, for example, heat generated by a light source 70.

The housing assembly 44 comprises a frame 54 and a bezel 56. The bezel 56 includes an inner surface 58 and an outer surface 60.

The frame 54 is of a rectangular shape and comprises a pair of elongated walls 62 and a pair of end caps 64. The elongated walls 62 and end caps 64 can be formed from sheet metal, aluminum, plastic or a like suitable material. Each elongated wall 62 is arranged opposite to and parallels the other 62. Each end cap 64 is also arranged opposite to and parallels the other 64. The elongated walls 62 and the end caps 64 are joined together to the inner surface 58 of the bezel 56 by a suitable joining means such as, for example, glue or screws (not illustrated). The elongated walls 62 and the end caps 64 are qualified to be received into the trough 48. The fit between the elongated walls 62 and the end caps 64 and the through 48 is an interference force fit.

Disposed on each end cap 64 is at least one light receptacle 66. Each light receptacle 66 is arranged directly opposite another light receptacle 66 disposed on the opposing end cap 64. Any multiple of opposing light receptacle 66 pairs can be provided. For example, as illustrated in FIGS. 3 and 5, the end cap 64 comprises two light receptacles 66.

Each light receptacle 66 is electrically connected to a power source (not illustrated) using the electrical wires and components 53 that route through the wire way assembly 42 and the housing 20 as described above. Coupled to the electrical wires and components 53 is an electrical connector assembly 68. The electrical connector assembly 68 comprises a first connector 69 that electrically mates with a second connector 71. The first connector 69 is located within the light fixture assembly 14. The second connector 71 is located within the housing 20. The electrical connector assembly 68 provides a simplified electronic connecting and disconnecting means for the light fixture assembly 14 and the power source. An industry example of the electrical connector 68 assembly is the Luminaire Disconnector, model number CN-02, and is available from Hui Yang Zing Ear Industry Co., LTD.

Received into the light receptacle 66 is a light source 70. The light source 70 may be, for example, an incandescent light bulb, a halogen light bulb, a fluorescent light bulb, or an LED. In the example illustrated, the light source 70 is a LED. Further, depending on application and the number of opposing light receptacle 66 pairs, the light source 70 may comprise a plurality. For example, illustrated in FIGS. 3 and 5 are two light sources 70. Moreover, each light source 70 may comprise a different color, such as, for example, a natural white color or a green color. When a plurality of light sources 70 are used, each light source 70 can be of the sample color or can each comprise a different color.

The light source 70 in cooperation with each opposing light receptacle 66 pair forms a complete electrical circuit. When power is provided to the electrical circuit, the light source 70 is illuminated. The wire way assembly 42, the elongated walls 62 and end caps 64 can all be coated with a white reflective paint to aid in providing a high level of reflectivity when the light source 70 is illuminated.

The light source 70 can operate in two modes: an ambient light mode and an examination light mode. In the ambient light mode, one light source 70 can be illuminated. In the examination light mode, more than one light source 70 can be illuminated, thereby increasing the intensity of the illumination. Further, each aforementioned light mode can be interconnected and controlled by an independent or a combination dimming control feature. The dimming control feature can adjust the amount of power transmitted from the power source to the light source 70, thereby either increasing or decreasing the number of light sources 70 illuminated and/or the intensity of the illumination generated by each light source 70.

With reference to FIG. 6, a first gasket 74 lines the inner surface 58 of the bezel 56. The first gasket 74 can be die-cut and formed from a suitable elastomeric plastic-like, rubber-like, or closed cell foam material. The first gasket 74 provides an insulative seal between the inner surface 58 of the bezel 56 and the housing 20 of the assembly 10. During assembly 10 use, the first gasket 74 serves to prevent airflow from leaking out between the bezel 56 and the housing 20. Moreover, the first gasket 74 serves to reduce noise that may be generated from vibration of the bezel 56 against the housing 20 when air flows through housing 20. The first gasket 74, coupled with a second gasket 90 described below, further serves to seal the light fixture assembly 14 and provides for the light fixture assembly 14 to achieve a UL-Damp location rating.

The UL Mark indicates that Underwriters Laboratories (UL) has tested and compared the light fixture assembly 14 to an established safety standard. The UL-Damp location rating signifies that the light fixture assembly 14 will continue to function properly, even if the electrical components of the light fixture assembly 14 come into contact with normal and/or periodic condensation or moisture. Because the environment into which the light fixture assembly 14 may be installed into can be prone to moisture from, for example, cleaning and/or sterilization of the light fixture assembly 14, or of the room environment, it is desired that the light fixture assembly 14 be able to withstand such normal and/or periodic condensation or moisture.

Once the light fixture assembly 14 is received into the housing 20 of the assembly 10, the light fixture assembly 14 achieves a UL-Wet location rating. A UL-Wet location rating signifies that the light fixture assembly 14 will continue to function properly, even if water or other liquids drip, splash or flow onto or against the electrical components of the light fixture assembly 14. Again, for the reasons mentioned above, it is desirable that the light fixture assembly 14 be able to withstand direct contact with moisture.

The perimeter of the outer surface 60 of the bezel 56 comprises a chamfered edge 76. Like the frame portion 34 and the airflow diffuser panel 32, the outer surface 60 of the bezel 56 can also comprise an aesthetic, decorative finish, such as, for example, a color and grain (not illustrated) to match the accent and decor of the surrounding environment into which the assembly 10 is installed.

The light diffuser assembly 46 is attached to the bezel 56. With reference to FIGS. 5 and 6, the light diffuser assembly 46 comprises a lens frame 80 and a light diffuser 82. The lens frame 80 can be fabricated from sheet metal, aluminum, plastic or a like suitable material. The lens frame 80 includes an inner surface 84 and an outer surface 86. The inner surface 84 may include a pair of C-shaped channels 88.

The lens frame 80 engages the bezel 56 with an interference snap-fit. The snap-fit between the lens frame 80 and the bezel 56 facilitates unrestricted installation and removal of the light diffuser assembly 46 from the housing assembly 44, and ultimately from the light fixture assembly 14. In another example (not illustrated), the lens frame 80 can be coupled to the bezel 56 by other fastening means, such as, for example, screws or pegs.

The second gasket 90, similar to the first gasket 74 described above, lines the inner surface 84 of the lens frame 80. Like the first gasket 74, the second gasket 90 serves to prevent airflow from leaking out between the lens frame 80 and the bezel 56 during operation. Moreover, the second gasket 90 serves to reduce or eliminate any vibration that can be generated between the lens frame 80 and the bezel 56 when air is flowing through the housing 20. Further, as described above, the second gasket 90, in cooperation with the first gasket 74, also serves to seal the light fixture assembly 14 and provide for the light fixture assembly 14 to achieve both a UL-Damp location rating and a UL-Wet location rating when received into the housing 20 of the assembly 10.

The light diffuser 82 is preferably formed from a single piece of frosted, opaque, low brightness and high impact plastic or acrylic material. The light diffuser 82 minimizes the appearance of hot spots, focused light and/or uneven light patterns by homogenizing the beams of light generated by the light source 70. The light diffuser 82 also helps to distribute the illumination generated by the light source 70 more evenly. The material selected for the light diffuser 82 is preferably solid, yet flexible enough to allow the light diffuser 82 to flex without cracking.

The light diffuser 82 is slid-into or flexed and snapped-into the C-shaped channels 88 on the lens frame 80. The light diffuser 82 can also be slid-out of or flexed and snapped-out of the C-shaped channels 88 to facilitate access to the light source 70 during service and/or other maintenance.

The entire light fixture assembly 14 is removable from the housing 20. With continued reference to FIGS. 5 and 6, a plurality of apertures 37 pass through the bezel 56. The apertures 37 cooperate with a further plurality of fasteners 39, which can be the same quarter-turn fasteners described above, to detachably-fasten the housing assembly 44, including the attached light diffuser assembly 46, to the housing 20. By removing the fasteners 39 and applying a downward pressure onto the bezel 56, the frame 54 is able to be separated from the trough 48. The first electrical connector 69 can be disconnected from the second electrical connector 71. By removing the light fixture assembly 14 from the assembly 10, preventative maintenance on the light fixture assembly 14 and/or on any of the other components associated with the light fixture assembly 14 and the airflow diffuser unit 12 can be performed.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification and the following claims.

What is claimed is:

1. An assembly comprising:
an airflow diffuser unit comprising a housing coupled to a source of airflow, said airflow diffuser unit further comprising an airflow diffuser panel coupled to the housing, said airflow is directed through the housing and the airflow diffuser panel; and
a light fixture assembly comprising at least one light receptacle, said light fixture assembly being received within and coupled to the housing so that the airflow is directed to the light fixture assembly.

2. The assembly of claim 1, wherein the light fixture assembly is secured to the housing with at least one fastener for removing the light fixture assembly from the housing.

3. The assembly of claim 1, wherein the light fixture assembly further comprises a first electrical connector coupling to a second electrical connector disposed within the housing.

4. The assembly of claim 1, wherein the light fixture assembly comprises a frame having at least one port receiving at least a portion of the airflow from within the housing.

5. The assembly of claim 1, wherein the airflow diffuser panel is a laminar airflow diffuser panel providing laminar airflow from the housing.

6. The assembly of claim 1, wherein an LED is electrically coupled to the at least one light receptacle.

7. The assembly of claim 1, wherein the light fixture assembly further comprises a bezel including an inner surface and an outer surface.

8. The assembly of claim 7, wherein a first gasket is disposed on the inner surface of the bezel.

9. The assembly of claim 7, wherein a lens frame is received into the bezel, said lens frame includes an inner surface and an outer surface.

10. The assembly of claim 9, wherein a second gasket is disposed between the inner surface of the lens frame and the outer surface of the bezel.

11. The assembly of claim 9, wherein the inner surface of the lens frame further comprises a C-channel and wherein a light diffuser is received into the C-channel.

12. A fixture comprising:
an airflow diffuser unit comprising a housing coupled to a source of airflow, said airflow diffuser unit further comprising a laminar airflow diffuser panel secured to the housing, said airflow is directed through the housing and the laminar airflow diffuser panel;
a light fixture assembly received into the airflow diffuser unit and secured to the housing, said airflow is directed toward and into the light fixture assembly; said light fixture assembly comprising a frame coupled to a bezel, said frame comprising at least one light receptacle, said light fixture assembly further comprising a lens frame coupled to the bezel and receiving a light diffuser.

13. The fixture of claim 12, wherein the frame comprises at least one port receiving at least a portion of the airflow from within the housing.

14. The fixture of claim 12, wherein the bezel includes an inner surface and an outer surface and the lens frame includes an inner surface and an outer surface.

15. The fixture of claim 14, wherein a first gasket is disposed on the inner surface of the bezel.

16. The fixture of claim 14, wherein a second gasket is disposed between the outer surface of the bezel and the inner surface of the lens frame.

17. The fixture of claim 14, wherein the inner surface of the lens frame further comprises a C-shaped channel and wherein the light diffuser is received into the C-shaped channel.

18. The fixture of claim 12, wherein an LED is electrically coupled to the at least one light receptacle.

19. The fixture of claim 12, wherein the light fixture assembly further comprises a first electrical connector coupling to a second electrical connector disposed within the housing.
